(19) United States
(12) Patent Application Publication
(10) Pub. No.: US 2009/0314936 A1
(43) Pub. Date: Dec. 24, 2009

(54) Sample target having sample support surface whose face is treated, production method thereof, and mass spectrometer using the sample target

(76) Inventor: Yoshinao Okuno, Mino-shi (JP)

Correspondence Address: NIXON & VANDERHYE, PC, 901 NORTH GLEBE ROAD, 11TH FLOOR, ARLINGTON, VA, 22203, US

(21) Appl. No.: 10/590,822

(22) PCT Filed: Feb. 24, 2005
(86) PCT No.: PCT/JP05/03055

§ 371 Date: Nov. 19, 2008

(30) Foreign Application Priority Data
Feb. 26, 2004 (JP) 2004-052521
Feb. 26, 2004 (JP) 2004-052522

(51) Int. Cl. H01J 49/26; H01J 99/00; B29C 59/16

(52) U.S. Cl. 250/288; 250/453.11; 264/447

(57) ABSTRACT

In mass spectrometry which allows ionization of a sample without using any matrix, there are provided (i) a sample target which improves efficiency and stability of the ionization so as to be more practical and (ii) a production method thereof. The sample target includes, as a sample support surface, a surface which is used to support a sample in ionizing the sample on the basis of laser irradiation so as to perform mass spectrometry and which has a finely bumpy structure of an order ranging from nanometer to several dozen micrometer, wherein a face of the sample support surface is coated with metal. Further, the bumpy structure of the sample support surface is preferably arranged so that a plurality of concave portions are regularly formed so as to have an interval of not less than 1 nm and less than 30 μm. In the sample target, the concave portion has a trench shape, a lattice shape, or a cylindrical or prismatic shape. The sample target is produced in accordance with lithography.

### TECHNICAL FIELD

The present invention relates to (i) a sample target used in mass spectrometry and a production method thereof and (ii) a mass spectrometer using the sample target. Particularly, the present invention relates to (a) a sample target which allows ionization of a sample without using any matrix and a production method thereof and (b) a mass spectrometer using the sample target.

### BACKGROUND ART

Mass spectrometry is analysis in which a sample is ionized and a ratio between a mass of a sample or sample fragment ions and electric charge (hereinafter, the ratio is referred to as “m/z value”) is measured so as to analyze a molecular weight of the sample. As the mass spectrometry, there is known Matrix-assisted laser desorption ionization (MALDI) in which a low molecular weight organic compound referred to as a matrix is mixed with a sample and laser is irradiated to the mixture so as to ionize the sample. According to the method, laser energy absorbed in the matrix is transmitted to the sample, so that it is possible to favorably ionize the sample.

MALDI allows ionization of a thermally instable substance and a polymer substance, so that this method allows “softer” ionization of the sample than other ionization techniques. Therefore, this method is widely adopted to mass spectrometry of various substances such as biopolymer, endocrine disrupter, synthetic polymer, metallic complex, and the like.

However, MALDI uses an organic compound matrix, so that it may be difficult to analyze sample ions depending on related ions derived from the matrix. Specifically, in case where the organic compound matrix is used, there are observed matrix-related ions such as (i) matrix molecule ions, (ii) cluster ions caused by hydrogen bond of matrix molecules, (iii) fragment ions generated by decomposition of matrix molecules, so that it is often difficult to analyze the sample ions.

As such, various techniques for avoiding disturbance of the matrix-related ions have been conventionally proposed. Specifically, there is known a technique in which the matrix molecules are fixed so as not to generate the matrix-related ions.

For example, there is disclosed a technique in which a matrix such as a-cyano-4-hydroxy cinnamic acid and cinnamamide is fixed to cephalos beads (for example, see Document 1: T. W. Hutchens and T. T. Yip, Rapid Commun. Mass Spectrum., 7, p. 576-580 (1993)). Further, there is disclosed a technique in which a self-assembled monomolecular membrane of methyl-N-(4-mercaptophenyl-carbamate serving as a matrix is formed on a surface of targeted gold (for example, see Document 2: S. Mouradian, C. M. Nelson, and L. M. Smith, J. Am. Chem. Soc., 118, p 8639-8645 (1996)). Furthermore, there is disclosed a technique in which 2,5-dihydroxy benzoic acid (DHB) serving as a matrix is fixed in a silicon polymer sheet on the basis of Sol-Gel processing (for example, see Document 3: Y. S. Lin and Y. C. Chen, Anal. Chem., 74, p. 5793-5798 (2002)). Particularly in the technique of Document 3, it is reported that a low molecular weight organic substance, amino acid, and peptide can be observed with high sensitivity without generating any matrix-related ions in a low molecular weight region.

However, the method in which the matrix is fixed in the foregoing manner raises such a problem that detection sensitivity and durability are insufficient in practical use. Further, the method also raises such a problem that it is impossible to avoid a noise caused by the fragment ions.

Thus, a technique using no matrix has been proposed recently. Specifically, there is disclosed a technique in which a porous semiconductor substrate (in the document, referred to as “porous light-absorbing semiconductor substrate) is used as a sample target (for example, see Document 4: U.S. Pat. No. 6,288,390 (Nov. 9, 2001)). The sample target is obtained by treating a sample support surface of the semiconductor substrate so as to have a porous structure, i.e., a finely bumpy structure. This Document reports that: in case where a laser beam is irradiated to a sample applied to the sample support surface, a high molecular weight substance is ionized even when there is no matrix. This method is referred to as “DIOS” (Desorption/Ionization on Silicon).

Note that, in the sample target, when the sample support surface having the finely bumpy structure is oxidized, the sample is less efficiently ionized. As such, chemical modification is performed with an organic compound in order to suppress oxidization of the surface. However, in case where the sample support surface is chemically modified with an organic compound in order to avoid drop in the sample ionization efficiency which is caused by oxidization of the sample support surface, the oxidization is suppressed, but the sample is less efficiently ionized than the case where the sample support surface is not chemically modified. In case where the intensity of the laser beam is raised in order to avoid drop in the ionization efficiency which is caused by the chemical modification, ions of the sample are likely to be decomposed, so that it is difficult to obtain accurate analysis results.

As described, in case where the sample support surface of the sample target is chemically modified in order to suppress drop in the ionization efficiency, the chemical modification causes the ionization efficiency to drop. In case of avoiding this trouble, it is difficult to perform stable ionization. Thus, the laser desorption ionization based on DIOS is required to improve the ionization efficiency and ionization stability so that the method is more practical.

The present invention was made in view of the foregoing problems, and an object of the present invention is to provide, concerning mass spectrometry which allows ionization of a sample without using any matrix, (i) a sample target and a production method thereof each of which allows more efficient and more stable sample ionization and (ii) a mass spectrometer using the sample target.

Further, according to the mass spectrometry based on DIOS, the sample target used therein is arranged so that the finely bumpy structure of the sample support surface is formed on the basis of electrolytic etching (for example, see Document 4, Document 5: J. Wei, J. M. Buriak, and G. Siuzdak, Nature, 399, p. 243-246 (1999), Document 6: Z. Shen, J. J. Thomas, C. Averbuj, K. M. Broo, M. Engelhard, J. E. Crowell, M. G. Finn, and G. Siuzdak, Anal. Chem., 73, p. 612-619 (2001)). FIG. 7 is a cross sectional view illustrating a condition under which a conventional sample target used in DIOS is treated. As illustrated in FIG. 7, the sample support surface of the sample target has an irregularly bumpy structure.

However, the mass spectrometry based on DIOS in which the sample support surface has the irregularly bumpy structure in this manner raises such a problem that an analysis result obtained therefrom is likely to be less stable.

Specifically, in producing the sample target used in DIOS, formation of the bumpy structure of the sample support surface is greatly influenced by conditions at the time of the electrolytic etching, e.g., by semiconductor material resistivity, etching current density, light intensity, electrolysis time, and the like. In other words, in forming the finely bumpy structure on the basis of the electrolytic etching, it is necessary to control a great number of the conditions. Therefore, it is difficult to form a similar bumpy structure with high reproducibility. This influences the sample ionization. FIG. 7 illustrates an example of the cross section of the conventional sample target actually used in DIOS. As illustrated in FIG. 7, the bumpy structure of the sample support surface has an irregular shape.

As a result, the sample ionization is less stable, so that an analysis result obtained therefrom is less stable. Thus, the mass spectrometry based on DIOS is required to be more practical.

The present invention was made in view of the foregoing problems, and an object of the present invention is to provide, concerning mass spectrometry based on DIOS, (i) a sample target and a production method thereof each of which improves stability of an analysis result obtained from the analysis and makes the analysis more practical and (ii) a mass spectrometer using the sample target.

### DISCLOSURE OF INVENTION

In view of the foregoing problems, the inventors of the present invention diligently studied. As a result of the diligent study, they uniquely found it possible to more efficiently and more stably ionize the sample not by suppressing oxidization of the finely bumpy structure but by raising conductivity due to metal coating. In this way, they completed the present invention.

Further, they uniquely found it possible to form a structure of the sample support surface of the sample target with high reproducibility by forming the finely bumpy structure in a regular manner, which results in a more stable analysis result obtained from the mass spectrometry based on DIOS. In this way, they completed the present invention.

That is, in order to solve the foregoing problems, a sample target according to the present invention includes, as a sample support surface, a surface which is used to support a sample in ionizing the sample on the basis of laser irradiation so as to perform mass spectrometry and which has a finely bumpy structure of an order ranging from nanometer to several dozen micrometer, wherein a face of the sample support surface is coated with metal.

It is preferable that the metal is at least either platinum (Pt) or gold (Au).

It is preferable that the bumpy structure of the sample support surface is arranged so that a plurality of concave portions are regularly formed.

Further, the sample target according to the present invention may include, as a sample support surface, a surface which is used to support a sample in ionizing the sample on the basis of laser irradiation so as to perform mass spectrometry and which has a finely bumpy structure of an order ranging from nanometer to several dozen micrometer, wherein the bumpy structure of the sample support surface is arranged so that a plurality of concave portions are regularly formed.

The sample target in which the bumpy structure of the sample support surface is arranged so that a plurality of concave portions are regularly formed is preferably arranged so that an interval of the concave portions adjacent to each other is not less than 1 nm and less than 30 μm.

Further, the sample target in which the bumpy structure of the sample support surface is arranged so that a plurality of concave portions are regularly formed is preferably arranged so that a width of each of the concave portions is not less than 1 nm and less than 30 μm.

The sample target in which the bumpy structure of the sample support surface is arranged so that a plurality of concave portions are regularly formed is preferably arranged so that a depth of each of the concave portions is not less than 1 nm and less than 30 μm.

The sample target in which the bumpy structure of the sample support surface is arranged so that a plurality of concave portions are regularly formed is preferably arranged so that each of the concave portions is a trench or a hole.

It is preferable that: when each of the concave portions is a trench, the concave portions are repeatedly disposed so that trenches in different directions intersect with each other.

Further, it is preferable that: when each of the concave portions is a hole, the hole has a cylindrical shape or a prismatic shape.

It is preferable that a material of at least the sample support surface of the sample target is a semiconductor, and it is more preferable that the semiconductor is silicon (Si).

A method according to the present invention for producing a sample target including, as a sample support surface, a surface which is used to support a sample in ionizing the sample on the basis of laser irradiation so as to perform mass spectrometry and which has a finely bumpy structure of an order ranging from nanometer to several dozen micrometer, and the method includes the step of coating a face of the sample support surface with metal.

Further, the method according to the present invention for producing the sample target preferably includes the step of repeatedly disposing concave portions on a surface of a substrate in accordance with lithography so that an interval of the concave portions is not less than 1 nm and less than 30 μm and a width of each of the concave portions is less than 30 μm, before performing the step of coating the face of the sample support surface with the metal, so as to form the sample support surface on the surface of the substrate.

The method according to the present invention for producing a sample target including, as a sample support surface, a surface which is used to support a sample in ionizing the sample on the basis of laser irradiation so as to perform mass spectrometry and which has a finely bumpy structure of an order ranging from nanometer to several dozen micrometer, and the method may include the step of repeatedly disposing concave portions on a surface of a substrate in accordance with lithography so that an interval of the concave portions is not less than 1 nm and less than 30 μm and a width of each of the concave portions is less than 30 μm, so as to form the sample support surface on the surface of the substrate.

It is preferable that the concave portions are formed by using an electron beam drawing apparatus as the lithography.

A mass spectrometer according to the present invention uses any one of the aforementioned sample targets so as to perform mass spectrometry. Further, it is preferable that the mass spectrometer is a laser desorption ionization mass spectrometer which ionizes the sample to be measured by irradiating laser to the sample so as to measure a molecular weight of the sample.

### BRIEF DESCRIPTION OF DRAWINGS

FIG. 1 is a cross sectional view illustrating an example of a bumpy structure of a surface of a sample target in one embodiment. Note that, the cross sectional view is obtained by observing the sample target of the present invention with a scanning electron microscope.

FIG. 2 is a schematic illustrating a trench shape of the sample target of FIG. 1. (a) is a perspective view illustrating a part of the sample target. (b) is a plan view of the sample target, illustrated in (a), which is viewed in a direction indicated by an arrow A. (c) is a cross sectional view of the sample target, illustrated in (a), which is viewed in a direction indicated by an arrow B.

FIG. 3 is a schematic illustrating a trench shape of a lattice-type sample target. (a) is a perspective view illustrating a part of the sample target. (b) is a plan view of the sample target, illustrated in (a), which is viewed in a direction indicated by an arrow A. (c) is a cross sectional view of the sample target, illustrated in (a), which cross sectional view is taken along a broken line B.

FIG. 4 is a schematic illustrating a trench shape of a hole-type sample target. (a) is a perspective view illustrating a part of the sample target. (b) is a plan view of the sample target, illustrated in (a), which is viewed in a direction indicated by an arrow A. (c) is a cross sectional view of the sample target, illustrated in (a), which cross sectional view is taken along a broken line B.

FIG. 5 is a mass spectrum obtained by performing mass spectrometry measurement with respect to TRITON X-100 with use of a sample target produced in Example 5.

FIG. 6 is a mass spectrum obtained by performing mass spectrometry measurement with respect to polypropyleneglycol with use of the sample target produced in Example 5.

FIG. 7 is a cross sectional view indicative of a treated surface of a sample target used in conventional DIOS. Note that, the cross sectional view is obtained by observing the sample target with a scanning electron microscope.

FIG. 8 is a cross sectional view indicative of a treated sample support surface of a sample target (product of Mass Consortium) used in Example 1. Note that, the cross sectional view is obtained by observing the sample target with a scanning electron microscope.

FIG. 9 illustrates a result obtained by observing a surface of a porous plastic Porex (product of U.S.A. POREX TECHNOLOGIES), used in Example 2, with a scanning electron microscope.

### BEST MODE FOR CARRYING OUT THE INVENTION

The following details one embodiment of the present invention, but the present invention is not limited to this.

As described above, when chemical modification is performed with an organic compound in order to suppress oxidization of a sample support surface having a finely bumpy structure, an ionization efficiency drops compared with a case where the chemical modification is not performed, so that it is impossible to ionize the sample unless laser intensity is raised compared with the case where the chemical modification is not performed. The cause thereof has not been found at the present but may be as follows: The chemical modification of the sample support surface reduces conductivity, so that electron movement between a sample target and the sample which electron movement is important in ionizing the sample is disturbed; Charge-up is likely to occur and electric charge is accumulated on the sample target, so that this results in inefficient ionization; and a similar cause. The inventors of the present invention focused on this point, and came to think it may be possible to solve the foregoing problems by coating a face of the sample support surface having the finely bumpy structure with metal so that the conductivity of the face of the sample support surface is enhanced. Further, they found it possible to more efficiently and more stably ionize the sample while suppressing oxidization of the sample support surface by actually coating the face with metal so that the conductivity of the face of the sample support surface is enhanced. In this way, they completed the present invention.

That is, the sample target according to the present invention is used to support the sample in performing mass spectrometry by ionizing the sample on the basis of laser irradiation, and the sample target includes, as the sample support surface, a surface having a finely bumpy structure of an order ranging from nanometer to several dozen micrometer, wherein a face of the sample support surface is coated with metal.

As described above, the inventors of the present invention coated the sample support surface with metal in order to solve the foregoing problems which occur in case of using the chemical modification based on the organic compound so that oxidization of the sample support surface having the finely bumpy structure is suppressed, thereby finding it possible to greatly improve the ionization efficiency. That is, the conductivity of the sample support surface was improved by coating the sample support surface with metal, and this may be a cause of great improvement of the ionization efficiency. Thus, the sample target according to the present invention is a sample target, coated with metal, whose ionization efficiency is improved by raising the conductivity of the sample support surface. Therefore, as the sample target of the present invention, also a sample target whose sample support surface is coated with oxidized metal is used. In case where metal hard to oxidize is used, the ionization efficiency is improved and oxidization of the sample support surface having the bumpy structure is suppressed.

Recently, in the nanotechnology field, there has been developed a technique for performing refinement such as 1 nm to several dozen μm refinement in order to produce a DNA chip, a semiconductor device, a fine container used in chemical reaction, and a similar product. In these years, the nanotechnology has been more widely applied to various fields. Accordingly, the refinement technique has been more required, so that the technical level has been rapidly rising. According to the refinement technique used in the nanotechnology, it is possible to more stably refine the fine structure of order ranging from 1 nm to several dozen μm than the conventional electrolytic etching.

The inventors of the present invention focused on the refinement technique used in the nanotechnology, and came to think that the fine structure which is so simple as to be easily treated can be adopted to treat the surface of the sample target used in the laser desorption ionization. Further, the inventors found that: if the refinement technique is actually used, it is possible to stably produce a regularly bumpy shape on the surface, thereby stably producing a sample target whose quality is high.

That is, as the sample target according to the present invention, there is used a sample target which is used to support the sample in performing mass spectrometry by ionizing the sample on the basis of laser irradiation and which includes, as the sample support surface, a surface having a finely bumpy structure of order ranging from nanometer to several dozen micrometer, wherein a surface of the sample support surface is coated with metal, and the bumpy structure of the sample support surface is arranged so that a plurality of concave portions are regularly formed.

As the sample target of the present invention whose sample support surface is coated with metal, the production method thereof, and the mass spectrometer using the sample target, the following explains (I) Sample target, (II) Production method of sample target, and (III) Usage of the present invention (mass spectrometer).

### (I) Sample Target

### (I-1) Sample Target, Sample Support Surface

The sample target according to the present invention is used in a laser desorption ionization mass spectrometer for performing mass spectrometry by ionizing the sample on the basis of laser irradiation, and functions as a sample table on which a sample to be analyzed is placed.

The sample target may be arranged in any manner as long as the sample target includes the sample support surface serving as a surface for supporting the sample. Structures, shapes, material, and the like of portions other than the sample support surface are not particularly limited.

Examples of a material of the sample target include: semiconductor; metal; resin such as synthetic polymer; ceramic; a composite having plural kinds of these materials; and the like. Specific examples of the composite include: a multilayered structure obtained by coating a surface of a metal layer with a semiconductor; a multilayered structure obtained by coating a surface of a resin layer with a semiconductor; a multilayered structure obtained by coating a ceramics surface with a semiconductor; and a similar structure. However, the composite is not limited to them.

In the sample support surface of the sample target according to the present invention, a surface supporting the sample to be analyzed receives irradiated laser while supporting the sample.

The material of the sample support surface is not particularly limited, but examples thereof include: semiconductor; metal; resin such as synthetic polymer; ceramics; and the like. It is possible to improve the ionization of a material having no conductivity by coating the material with metal. A preferable example of the material of the sample support surface is semiconductor. By using the semiconductor, it is possible to more effectively ionize the sample.

Note that, any semiconductor may be used as the foregoing semiconductor. Particularly, it is preferable to use, for example, Si, Ge, SiC, GaP, GaAs, InP, Si₁₋ₓGeₓ(0<X<1), and the like. It is more preferable to use Si.

Further, examples of the foregoing metal include: the periodic table's 1A group (Li, Na, K, Rb, Cs, Fr); 2A group (Be, Mg, Ca, Sr, Ba, Ra); 3A group (Sc, Y); 4A group (Ti, Zr, Hf); 5A group (V, Nb, Ta); 6A group (Cr, Mo, W); 7A group (Mn, Tc, Re); 8 group (Fe, Ru, Os, Co, Rh, Ir, Ni, Pd, Pt); 1B group (Cu, Ag, Au); 2B group (Zn, Cd, Hg); 3B group (Al); lanthanoid (La, Ce, Pr, Nd, Pm, Sm, Eu, Gd, Tb, Dy, Ho, Er, Tm, Yb, Lu); actinoid (Ac, Th, Pa, U, Np, Pu, Am, Cm, Bk, Cf, Es, Fm, Md, No, Lr); and the like.

Examples of the synthetic polymer include: polyethylene, polypropylene, polyacrylate ester, polymethacrylate ester, polystylene, polysiloxane, polystanoxane, polyamide, polyester, polyaniline, polypyrrole, polythiophene, polyurethane, polethyletherketone, poly4-ethylene fluoride, a copolymer thereof or a mixture thereof, graft polymer and block polymer.

Further, examples of the ceramics include alumina (aluminum oxide), magnesia, beryllia, zirconia (zirconium dioxide), uranium oxide, thorium oxide, sirica (quartz), forsterite, steatite, walastenite, zircon, mullite, cordierite, spodumene, aluminum titanate, spinel apatite, barium titanate, ferrite, lithium niopate, silicon nitride, sialon, aluminum nitride, boron nitride, titanium nitride, silicon carbide, boron carbide, titanium carbide, tangsten carbide, lanthanum boride, titanium boride, zirconium boride, cadmium sulfide, molybdenum sulfide, molybdenum disilicide, amorphous carbon, graphite, diamond, single crystal sapphire, and the like.

(I-2) Finely Bumpy Structure of Order Ranging from Nanometer to Several Dozen Micrometer

The sample support surface according to the present invention includes a finely bumpy structure of order ranging from nanometer to several dozen micrometer. The “finely bumpy structure of order ranging from nanometer to several dozen micrometer” ordinarily means a bumpy structure which is so fine as to be represented in view of a nanometer unit or a several dozen micrometer unit. Further, such a fine unit as to be represented in view of a nanometer unit or a several dozen micrometer unit is specifically 1 nm to several dozen μm. Further, the sample support surface of the sample target according to the present invention may be arranged in any manner as long as the sample support surface has the finely bumpy structure of order ranging from nanometer to several dozen micrometer, but it is preferable that the sample support surface has the finely bumpy structure of nanometer order. The “finely bumpy structure of nanometer order” ordinarily means a bumpy structure which is so fine as to be represented in view of a nanometer unit. Further, the bumpy structure which is so fine as to be represented in view of a nanometer unit specifically means a size of not less than 1 nm and less than 1 μm.

The finely bumpy structure of order ranging from nanometer to several dozen micrometer is not particularly limited as long as the following condition is satisfied: the sample support surface having such a structure is coated with metal, and a sample is placed thereon, and laser irradiation on the sample causes ionization of a high molecular weight substance without any matrix. For example, also a porous structure of a sample target used in the laser desorption ionization mass spectrometry based on DIOS is regarded as the foregoing bumpy structure.

The size of the finely bumpy structure of the sample support surface is arbitrarily set as long as the size is an order ranging from nanometer to several dozen micrometer, that is, 1 nm to several dozen μm. That is, an interval between each concave portion and each convex portion adjacent thereto in the bumpy structure ranges from 1 nm to several dozen μm. However, in order to improve the function as the sample target for mass spectrometry, the interval between each concave portion and each convex portion adjacent thereto is preferably not less than 1 nm and less than 30 μm, more preferably from 1 nm to 10 μm, still more preferably from 10 nm to 10 μm, yet still more preferably from 10 nm to 500 nm, particularly preferably from 10 nm to 300 nm. This allows favorable ionization of a sample measured in mass spectrometry.

Further, intervals each of which is between each concave portion and each convex portion adjacent thereto may be regular or may be irregular. However, in order to further improve the function as the sample target for mass spectrometry, it is preferable that the intervals are regular. In case where the intervals each of which is between each concave portion and each convex portion adjacent thereto are regular, the convexes and concaves are less uneven, so that the ionization performance is further stabilized.

A depth of each concave portion of the bumpy structure is arbitrarily set as long as the depth is not less than 1 nm and less than 30 μm. However, in order to further improve the function as the sample target for mass spectrometry, the depth preferably ranges from 10 nm to 1 μm, more preferably from 50 nm to 500 nm, particularly preferably from 100 nm to 500 nm. Further, depths of the concave portions may be uneven or may be even. However, in order to further improve the function as the sample target for mass spectrometry, it is preferable that the depths of the concave portions are even. In case where the depths of the concave portions are even, the convexes and the concaves are less uneven, so that the ionization performance is further stabilized.

A specific shape of the concave portion is not particularly limited, so that the concave portion may have any shape. Further, in the bumpy structure, the concave portions may have not a certain shape but a mixture of various shapes. However, in order to further improve the function as the sample target for mass spectrometry, it is preferable that the bumpy structure includes the concave portions having a certain shape. Examples of such a certain shape include a trench, a lattice in which trenches intersect with each other, a hole, and the like. Further, shapes of the trench and the hole are not particularly limited, and the trench and the hole may have any shapes. However, examples thereof include a linear trench, a curved trench, an arc trench, a round hole, an oval hole, a triangular, square, or pentangular hole, and the like.

Further, a sidewall of the concave portion may be perpendicular to the sample support surface or may be slanted with respect to the sample support surface.

Further, the bumpy structure may be formed on the whole sample support surface, or may be formed on part of the sample support surface.

As described above, it is more preferable that the bumpy structure on the sample support surface of the sample target of the present invention has a plurality of concave portions regularly formed thereon. A structure including such a plurality of concave portions regularly formed may be arranged in a manner which will be described later.

As described above, the bumpy structure of the sample support surface on the sample target of the present invention can be variously modified, and the modification can be selectively performed in consideration of simplicity at the time of production (refinement of the sample support surface) and cost taken to produce.

(I-3) Coating with Metal

The sample target according to the present invention is arranged so that a face of the sample support surface is coated with metal. Specific examples of the metal include: the periodic table's 1A group (Li, Na, K, Rb, Cs, Fr); 2A group (Be, Mg, Ca, Sr, Ba, Ra); 3A group (Sc, Y); 4A group (Ti, Zr, Hf); 5A group (V, Nb, Ta); 6A group (Cr, Mo, W); 7A group (Mn, Tc, Re); 8 group (Fe, Ru, Os, Co, Rh, Ir, Ni, Pd, Pt); 1B group (Cu, Ag, Au); 2B group (Zn, Cd, Hg); 3B group (Al); lanthanoid (La, Ce, Pr, Nd, Pm, Sm, Eu, Gd, Tb, Dy, Ho, Er, Tm, Yb, Lu); actinoid (Ac, Th, Pa, U, Np, Pu, Am, Cm, Bk, Cf, Es, Fm, Md, No, Lr); and the like. Particularly, it is more preferable that the metal is Au or Pt. Au or Pt is hard to oxidize, so that it is possible not only to improve the ionization efficiency but also to prevent oxidization of the sample support surface having the bumpy structure.

Further, the metal may be a single metal selected from the foregoing kinds of metal, or may be alloy made of two or more kinds selected from the foregoing kinds of metal. The alloy metal obtained by mixing two or more kinds. A state in which the mixture of two or more kinds of metal exists is not particularly limited. Examples thereof include solid solution, an intermetallic compound, a state in which the solid solution and the intermetallic compound are mixed, and a similar state.

The thickness of the metal with which the sample support surface is coated is not particularly limited as long as the thickness does not damage the bumpy structure of the sample support surface. Specifically, the thickness is preferably not less than 1 nm and not more than 100 nm. The thickness of the metal does not exceed the upper limit, so that the bumpy structure of the sample support surface is not damaged; The thickness is more than the lower limit, so that it is possible to efficiently perform the ionization. Further, the thickness of the metal is more preferably not less than 1 nm and not more than 50 nm, particularly preferably not less than 1 nm and not more than 30 nm. This allows more efficient ionization.

Further, the surface of the sample support surface may be coated with a plurality layers respectively made of plural kinds of metal selected from the foregoing kinds of metal.

### (II) Production Method of Sample Target

A method according to the present invention for producing a sample target including, as a sample support surface, a surface which is used to support a sample in ionizing the sample on the basis of laser irradiation so as to perform mass spectrometry and which has a finely bumpy structure of an order ranging from nanometer to several dozen micrometer, and the method includes the step of coating a face of the sample support surface with metal.

How to coat the face of the sample support surface with metal is not particularly limited, and it is possible to favorably adopt a conventionally known technique. Examples of the method include sputtering, chemical vapor deposition (CVD), vacuum deposition, electroless plating, electrolytic plating, application, noble metal varnish, organic metal thin film method, and the like. These treatments may be selectively adopted depending on a kind of the metal, the thickness of the coating layer, a condition of the coated sample support surface.

A method for producing the sample support surface having the finely bumpy structure of order ranging from nanometer to several dozen micrometer is not particularly limited, and it is possible to favorably adopt a conventionally known technique. Examples of the method include electrolytic etching, lithography, and the like. By adopting lithography, it is possible to produce the sample support surface having a regularly and finely bumpy structure.

The method according to the present invention for producing the sample target may be arranged so that: concave portions each having a width of less than 30 μm, more preferably less than 1 μm, are repeatedly disposed on a surface of a substrate in a regular manner in accordance with lithography so that an interval of the concave portions is not less than 1 nm and less than 30 μm, more preferably not less than 10 nm and less than 1 μm, before performing the step of coating the face of the sample support substrate, so as to form the sample support surface on the surface. Further, as the lithography, it is preferable to form the concave portions by using an electron beam drawing apparatus. A method for regularly forming the plurality of concave portions may be arranged in a manner which will be described in another embodiment.

### (III) Usage of the Present Invention (Mass Spectrometer)

The sample target of the present invention can be used as a sample table on which the sample to be measured is placed in performing mass spectrometry with respect to various substances such as biopolymer or endocrine disrupter, synthetic polymer, metal complex, and the like. Further, particularly in case where the sample target is used in laser desorption mass spectrometry, it is possible to efficiently and stably ionize the sample. Thus, the sample target is very useful.

Also a mass spectrometer using the sample target of the present invention is included in the scope of the present invention. Particularly in case where the sample target is used in a laser desorption mass spectrometer, it is possible to efficiently and stably ionize the sample. Thus, more specifically, it is preferable that the mass spectrometer of the present invention ionizes the sample to be measured on the basis of laser irradiation so as to measure a molecular weight of the sample.

In the laser desorption mass spectrometer, the sample to be measured is placed on the sample target, so that it is possible to favorably ionize the sample in case where laser is irradiated to the sample.

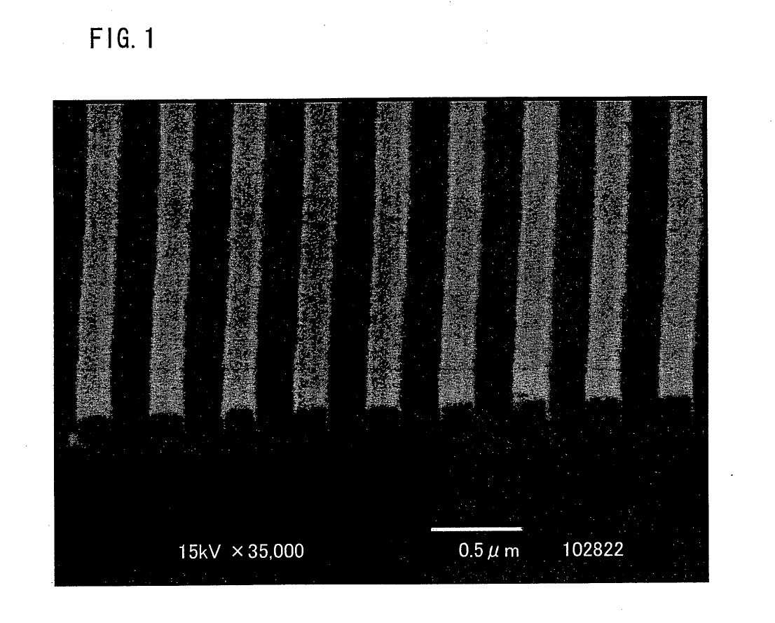

Next, with reference to FIG. 1 through FIG. 4, the following details another embodiment of the present invention, but the present embodiment is not limited to the following description.

Recently, in the nanotechnology field, there has been developed a technique for performing refinement such as 1 nm to several dozen μm refinement in order to produce a DNA chip, a semiconductor device, a fine container used in chemical reaction, and a similar product. In these years, the nanotechnology has been more widely applied to various fields. Accordingly, the refinement technique has been more required, so that the technical level has been rapidly rising. According to the refinement technique used in the nanotechnology, it is possible to more stably refine the fine structure of order ranging from 1 nm to several dozen μm than the conventional electrolytic etching.

The inventors of the present invention focused on the refinement technique used in the nanotechnology, and came to think that the fine structure which is so simple as to be easily treated can be adopted to treat the surface of the sample target used in the laser desorption ionization. Further, they found that: use of the refinement technique allows convexes and concaves to be regularly formed on the surface, which results in stable production of a sample target with high quality. In this way, they completed the present invention,

That is, the sample target according to the present invention may be a sample target which includes, as a sample support surface, a surface which is used to support a sample in ionizing the sample on the basis of laser irradiation so as to perform mass spectrometry and which has a finely bumpy structure of an order ranging from nanometer to several dozen micrometer, wherein the bumpy structure of the sample support surface is arranged so that a plurality of concave portions are regularly formed.

### (I) Sample Target

The following details the sample target according to the present embodiment.

The sample target according to the present embodiment is used in a laser desorption ionization mass spectrometer for performing mass spectrometry by ionizing a sample on the basis of laser irradiation, and functions as a sample table on which the sample to be measured is placed. In the sample target of the present embodiment, a surface for supporting the sample, that is, a sample support surface has a finely bumpy structure of order ranging from nanometer to several dozen micrometer. Further, the bumpy structure is such that a plurality of concave portions are repeatedly formed in a regular manner.

The sample support surface of the sample target has the finely bumpy structure of order ranging from nanometer to several dozen micrometer. The “finely bumpy structure of order ranging from nanometer to several dozen micrometer” ordinarily means a bumpy structure which is so fine as to be represented in view of a nanometer unit or a several dozen micrometer unit. Further, such a fine unit as to be represented in view of a nanometer unit or a several dozen micrometer unit is specifically 1 nm to several dozen μm. Further, the sample support surface of the sample target according to the present invention may be arranged in any manner as long as the sample support surface has the finely bumpy structure of order ranging from nanometer to several dozen micrometer, but it is preferable that the sample support surface has the finely bumpy structure of nanometer order. The “finely bumpy structure of nanometer order” ordinarily means a bumpy structure which is so fine as to be represented in view of a nanometer unit. Further, the bumpy structure which is so fine as to be represented in view of a nanometer unit specifically means a size of not less than 1 nm and less than 1 μm.

As described above, the concave portions formed on the sample support surface of the sample target according to the present embodiment are arranged so that a plurality of concave portions are regularly provided. The “arrangement in which a plurality of concave portions are regularly provided” means an arrangement in which a plurality of concave portions are repeated with a certain regularity. A specific example of the arrangement is an arrangement in which trenches or holes are repeatedly provided (described later).

Further, in order to further improve the function as the sample target for mass spectrometry, an interval of concave portions adjacent to each other in the sample target is preferably not less than 1 nm and less than 30 μm, more preferably not less than 10 μm and less than 1 μm. The interval of concave portions adjacent to each other is so narrow as to be less than 30 μm, preferably less than 1 μm, so that it is possible to favorably ionize the sample to be measured in the mass spectrometry. Further, the interval of the concave portions adjacent to each other is not less than 1 nm, preferably not less than 10 nm, so that it is possible to prevent the strength of the sample target from dropping.

Further, an example of a specific shape of the concave portion is a trench or a hole. Such a shape can be easily and stably formed by the current nanotechnology such as lithography in case of performing surface treatment with respect to the sample support surface of the sample target.

In this case, a width of each concave portion is set to not less than 1 nm and less than 30 μm, more preferably not less than 10 nm and less than 1 μm, and a depth of each concave portion is set to not less than 1 nm and less than 30 μm, more preferably not less than 10 nm and less than 1 μm. The width and the depth of the concave portion are set in this manner, so that the size is substantially the same as a wavelength of ultraviolet laser of several hundreds nanometer, e.g., nitrogen laser of 337 nm, which is generally used in the current laser desorption ionization mass spectrometer. Thus, it is possible to favorably trap laser energy. Further, as long as the width and the depth of the concave portion are within the foregoing ranges, it is possible to obtain favorable ionization efficiency.

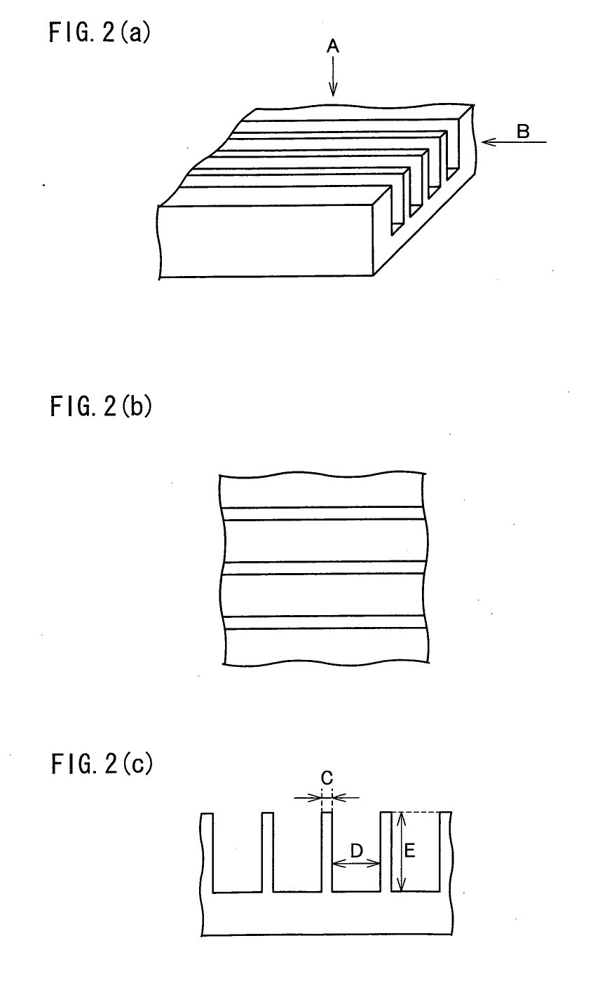

FIG. 1 illustrates a specific example of a shape of the sample support surface of the sample target in case where the concave portion is a trench. As illustrated in FIG. 1, the sample target according to the present embodiment may have such a shape that a plurality of trenches having an interval of not less than 1 nm and less than 30 μm, more preferably not less than 10 nm and less than 1 μm, are disposed in parallel to each other. The sample target having the shape illustrated in FIG. 1 is referred to as a trench-type sample target. Further, FIG. 2 schematically illustrates a shape of the trench of the trench-type sample target. (a) is a perspective view illustrating a part of the sample target. (b) is a plan view seen from the above of the sample support surface (from a direction A in (a)). (c) is a cross sectional view of the trench shape (cross sectional view seen from a direction B in (a)). The interval between the concave portions (trenches) means a size of a portion indicated by C of FIG. 2(c). The width of the concave portion (trench) means a size of a portion indicated by D of FIG. 2(c). The depth of the concave portion (trench) means a size of a portion indicated by E of FIG. 2(c).

In the trench-type sample target, when the interval between the trenches is less than 30 μm, more preferably less than 1 μm, it is possible to favorably ionize the sample placed on the sample target in case of performing the mass spectrometry. Further, when the interval between the trenches is not less than 1 nm, more preferably not less than 10 nm, it is possible to carry out treatment without using any high technique in the current refinement technique. Note that, in order to more favorably ionize the measured sample, it is more preferable that the interval between the trenches is less than 200 nm. While, in order to more easily perform refinement of the sample support surface at lower cost, the interval of the trenches is not less than 1 nm, more preferably not less than 10 nm.

Further, in the trench-type sample target, the width and the depth of the trench is preferably not less than 1 nm and less than 30 μm, more preferably not less than 10 nm and less than 1 μm. According to the arrangement, for example, it is easy to trap energy of ultraviolet laser of several hundreds nanometer order, e.g., nitrogen laser of 337 nm, so that it is possible to obtain favorable ionization efficiency. Note that, in order to more favorably ionize the measured sample, it is more preferable that the interval between the trenches is not less than 10 nm and less than 200 nm.

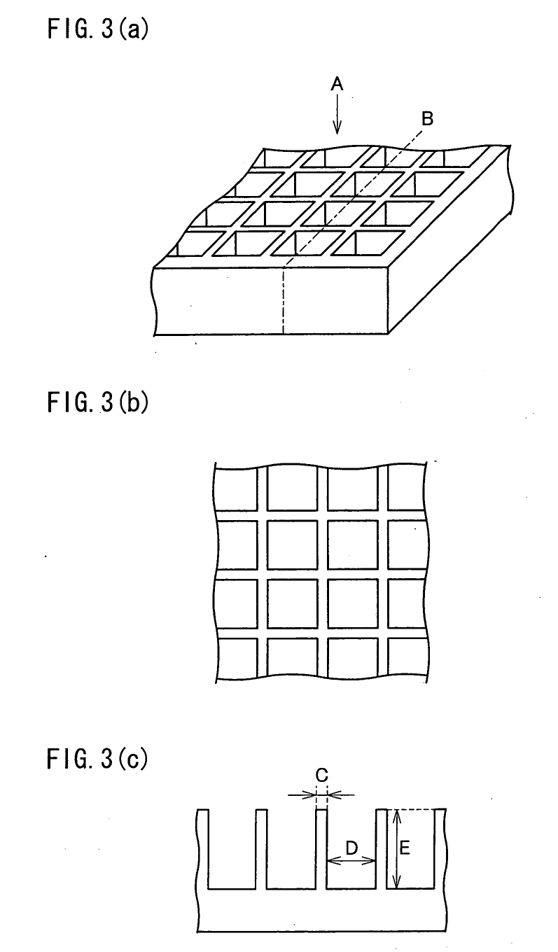

Note that, the trench-type sample target may be arranged so that the trenches are provided in two directions different from each other and the trenches in the two different directions intersect with each other. FIG. 3 illustrates an example of the sample target having such a trench arrangement. In FIG. 3, (a) is a perspective view illustrating a part of the sample target. (b) is a plan view seen from the above of the sample support surface (from a direction A in (a)). (c) is a cross sectional view of the trench shape (cross sectional view seen from a direction B in (a)). The sample target illustrated in FIG. 3 is arranged so that trenches in two different directions perpendicularly intersect with each other, and the sample target having the trenches is referred to as a lattice-type sample target. The interval between the concave portions (trenches) means a size of a portion indicated by C of FIG. 3(c). The width of the concave portion (trench) means a size of a portion indicated by D of FIG. 3(c). The depth of the concave portion (trench) means a size of a portion indicated by E of FIG. 3(c).

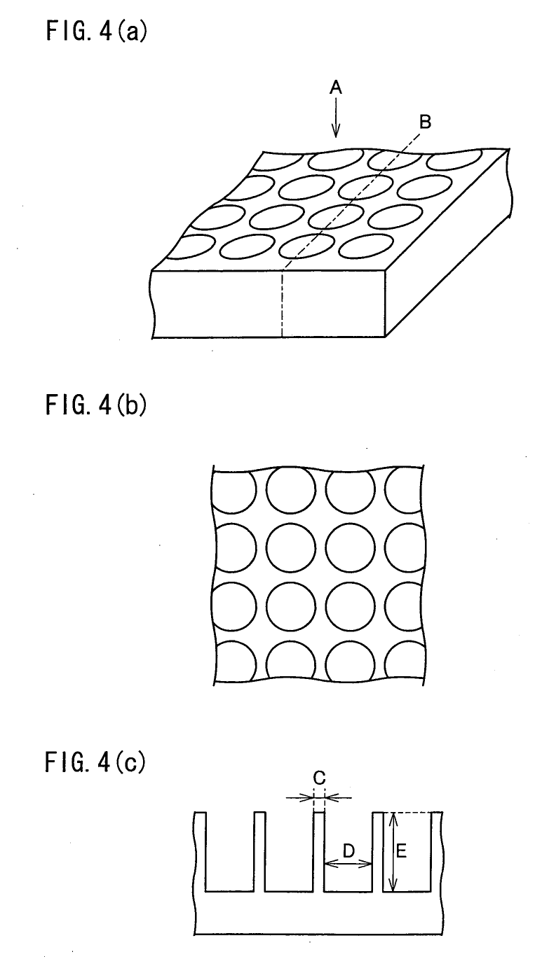

A shape of the concave portion of the sample target of the present embodiment is not limited to the trench type or the lattice type, and the concave portion may have any other shape. An example thereof is the concave portion having a hole shape illustrated in FIG. 4. The sample target illustrated in FIG. 4 is particularly arranged so that the hole has a cylindrical shape, and the sample target having the hole is referred to as a hole-type sample target. In FIG. 4, (a) is a perspective view illustrating a part of the sample target. (b) is a plan view seen from the above of the sample support surface (from a direction A in (a)). (c) is a cross sectional view of the trench shape (cross sectional view seen from a direction B in (a)).

The interval between the holes means a size of a portion indicated by C of FIG. 4(c). The width of the hole means a size of a portion indicated by D of FIG. 4(c). The depth of the hole means a size of a portion indicated by E of FIG. 4(c). Note that, the cross sectional view illustrated in FIG. 4(c) is a cross sectional view indicating also a diameter of the hole. Therefore, the width of the hole means a diameter of the cylindrical hole, and the interval between the holes means an interval between the holes which are adjacent to each other and are positioned closest to each other.

The hole of the hole-type sample target may have a prismatic shape such as a quadratic prism, a triangular prism, a pentagonal prism, a hexagonal prism, and the like, instead of the cylindrical shape illustrated in FIG. 4. In other words, the lattice-type sample target has a prism-shaped hole, so that the lattice-type sample target is regarded also as the hole-type sample target.

In the sample target having the trench-type, the lattice-type, or the hole-type structure, a sidewall of the concave portion is preferably perpendicular to a bottom surface of the sample target, but the sidewall may be slightly inclined. Further, in the lattice-type sample target, an angle at which the trenches in different directions intersect with each other is not limited to 90° illustrated in FIG. 3, but may be any angles other than 90°. Further, in the sample target having a cylindrical hole, it is not necessary that a shape of a cross section of the hole is completely circular, and the shape may be slightly changed into an oval shape or the like. It is not necessary that such structure occupies the whole portions of the sample target.

As described above, the shape of the concave portion of the sample target of the present embodiment can be variously modified, and the shape can be suitably selected in consideration for simplicity in the production (in refinement of the sample support surface) and production cost. Out of the trench-type structure, the lattice-type structure, and the hole-type structure, it is easiest to form the trench-type structure.

As materials of the sample target, semiconductor, metal, resin such as synthetic polymer, ceramics, and the like are used. Further, as the sample target, it is possible to adopt a composite containing plural kinds of the aforementioned materials, specifically, it is possible to adopt a coated structure in which a surface of the semiconductor is coated with metal or a coated structure in which a surface of the resin is coated with metal. Out of the materials, it is preferable to adopt the semiconductor because of advancement of the treatment technique and easiness to treat.

Note that, examples of the semiconductor include Si, Ge, SiC, GaP, GaAs, InP, Si₁₋ₓGeₓ (including semiconductors other than equimolal SiGe), and the like.

Further, examples of the metal include: the periodic table's 1A group (Li, Na, K, Rb, Cs, Fr); 2A group (Be, Mg, Ca, Sr, Ba, Ra); 3A group (Sc, Y); 4A group (Ti, Zr, Hf); 5A group (V, Nb, Ta); 6A group (Cr, Mo, W); 7A group (Mn, Tc, Re); 8 group (Fe, Ru, Os, Co, Rh, Ir, Ni, Pd, Pt); 1B group (Cu, Ag, Au); 2B group (Zn, Cd, Hg); 3B group (Al); lanthanoid (La, Ce, Pr, Nd, Pm, Sm, Eu, Gd, Tb, Dy, Ho, Er, Tm, Yb, Lu); actinoid (Ac, Th, Pa, U, Np, Pu, Am, Cm, Bk, Cf, Es, Fm, Md, No, Lr); and the like.

Further, examples of the synthetic polymer include polyethylene, polypropylene, polyacrylate ester, polymethacrylate ester, polystylene, polysiloxane, polystanoxane, polyamide, polyester, polyaniline, polypyrrole, polythiophene, polyurethane, polethyletherketone, poly4-ethylene fluoride, a copolymer thereof or a mixture thereof, graft polymer and block polymer.

Further, examples of the ceramics include alumina (aluminum oxide), magnesia, beryllia, zirconia (zirconium dioxide), uranium oxide, thorium oxide, sirica (quartz), forsterite, steatite, walastenite, zircon, mullite, cordierite, spodumene, aluminum titanate, spinel apatite, barium titanate, ferrite, lithium niopate, silicon nitride, sialon, aluminum nitride, boron nitride, titanium nitride, silicon carbide, boron carbide, titanium carbide, tangsten carbide, lanthanum boride, titanium boride, zirconium boride, cadmium sulfide, molybdenum sulfide, molybdenum disilicide, amorphous carbon, graphite, diamond, single crystal sapphire, and the like.

According to the foregoing sample target, in case of performing the laser desorption ionization mass spectrometry, it is possible to ionize the sample without using matrix molecules. In addition, unlike the conventional DIOS sample target produced by electrolytic etching, the foregoing sample target has a finely bumpy structure of nanometer or several dozen micrometer order so that the concave and convex are regularly formed therein. Thus, it is possible to stabilize the ionization performance.

### (II) Production Method of Sample Target

Next, a method of the present embodiment for producing the sample target is described as follows.

As described above, the sample target according to the present embodiment includes, as a sample support surface, a surface having a finely bumpy structure of order ranging from nanometer to several dozen micrometer, wherein the bumpy structure of the sample support surface is arranged so that concave portions each having a depth of 1 nm or more, more preferably 10 nm or more, are regularly formed. Therefore, in order to produce the sample target, it is necessary to adopt highly accurate refinement technique used in the nanotechnology.

Examples of the highly accurate refinement technique used in the nanotechnology include methods explained in “Nanotechnology Handbook” (edited by National Industrial Research Institute, Nanotechnology Knowledge Association, published by Nikkei BP in 2003) and “Nanotechnology Introduction” (written by Tomohito KAWAI, published by Ohmsha). Particularly, lithography is one of the most popular methods currently adopted in the refinement of order ranging from 10 nanometer to several dozen micrometer. As the lithography, there are methods such as photolithography, electron beam lithography, ion beam lithography, nanoimprint lithography, and dip-pen nanolithography. Out of these methods, it is preferable to adopt the electron beam lithography. If the electron beam lithography is adopted, the size of the written shape is not limited by the wavelength unlike the general optical lithography, so that it is possible to perform finer writing. As a result, it is possible to form a finely bumpy structure.

In the electron beam lithography, a draft of the device is printed onto a metal plate referred to as a mask, and treatment is performed so that a masked portion allows light to pass therethrough and other portion does not allow light to pass therethrough. Light is irradiated to the thus treated draft, and the light is focused by a lens, so that a pattern of the draft is projected with it scaled down. A photosensitive agent is applied to a material serving as a basis of the device in advance, and the pattern is projected onto the basis with it scaled down, so that the pattern of the draft is printed onto the basis.

The photosensitive agent applied to the basis is referred to as resist. The resist includes molecules which cause photo reaction such as reaction in which the resist is solidified upon receiving light or reaction in which the resist becomes hard to dissolve in polymerized solution. When a material of the basis on which the pattern has been printed is placed in solution for dissolving the material, it is possible to leave only solidified portions of the resist having received light and to dissolve other portions. The resist pattern formed in this manner is used and etching is performed, so that it is possible to perform refinement on the substrate. In the electron beam lithography, an electron beam drawing apparatus is generally used. The accuracy in providing the fine structure greatly depends on a performance of the electron beam drawing apparatus.

As described above, in case of producing the sample target according to the present embodiment, when the lithography technique is used, it is possible to perform refinement of order ranging from nanometer to several dozen micrometer order with respect to the sample support surface. Therefore, it is extremely effective to adopt the lithography technique as the production method of the sample target.

Also the method for producing the sample target by using the lithography technique is included in the scope of the present embodiment. The method of the present embodiment for producing the sample target is a production method of a sample target having, as a sample support surface, a surface which is used to support a sample in performing mass spectrometry by ionizing the sample on the basis of laser irradiation and has a finely bumpy structure of order ranging from nanometer to several dozen micrometer, wherein concave portions each having an interval of not less than 1 nm and less than 30 μm, more preferably not less than 10 nm and less than 1 μm, and a width of less than 30 μm, more preferably less than 1 μm, are repeatedly formed on a surface of a substrate in a regular manner so as to form the sample support surface on the surface.

That is, the method of the present embodiment for producing the sample target is based on the technique for refining the substrate surface, i.e., the technique in which concave portions having an interval of not less than 1 nm and less than 30 μm, more preferably not less than 10 nm and less than 1 μm, and a width of less than 30 μm, more preferably less than 1 μm, are regularly formed on a surface of a substrate by using lithography technique. Further, according to the method, it is possible to easily and highly accurately produce the sample target according to the present embodiment, that is, the sample target suitable for the laser desorption ionization mass spectrometry.

According to the method of the present embodiment for producing the sample target, it is possible to produce the sample target whose concave portion has a shape such as a trench, a lattice, a hole, or the like. As the highly accurate refinement technique for producing the sample target whose sample support surface is refined so as to have various shapes of order ranging from nanometer to several dozen micrometer, the aforementioned various types of lithography are used in the production method of the present embodiment.

In the production method of the present embodiment, out of the aforementioned lithography methods, it is preferable to adopt the electron beam lithography in which electrolytic etching is performed after applying a photosensitive agent into a predetermined shape by using the electron beam drawing apparatus. If the electron beam lithography is adopted, it is possible to perform finer writing than general optical lithography. As a result, it is possible to form a finely bumpy structure.

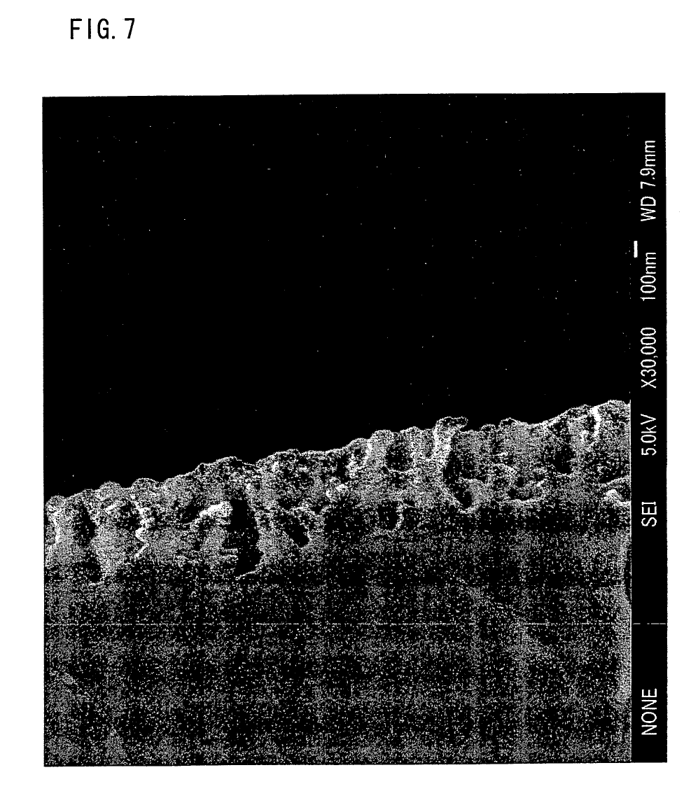

Further, the DIOS sample target produced by adopting only the conventional electrolytic etching has a complicated and irregular structure as illustrated by the cross sectional view of FIG. 7. While, according to the production method of the present embodiment, the lithography technique is adopted, so that it is easy to refine a simple and regularly fine structure such as a trench (see FIG. 1 and FIG. 2), a lattice (see FIG. 3), and a hole (see FIG. 4) with high accuracy and high reproducibility. Thus, in the sample target produced by the foregoing production method, shapes of convex and concave are less uneven between respective sample targets and between production lots. That is, according to the production method of the present embodiment, it is possible to provide a stable ionization performance to the resultant sample target.

### (III) Usage of the Invention (Mass Spectrometer)

Next, how to use the sample target of the present embodiment is described as follows.

The sample target of the present embodiment can be used as a sample table on which a sample to be measured is placed in case of performing mass spectrometry of various substances such as biopolymer, endocrine disrupter, synthetic polymer, metallic complex, and the like. Further, it is effective to use the sample target particularly in the laser desorption ionization mass spectrometry because the sample target allows favorable ionization of the sample.

Thus, also a mass spectrometer for performing mass spectrometry by using the sample target of the present embodiment is included in the scope of the present invention. That is, the mass spectrometer of the present invention includes the sample target of the present embodiment as components of the sample table. The sample target allows favorable ionization of the sample particularly in case where the sample target is used in the laser desorption ionization mass spectrometer. Therefore, more specifically, the mass spectrometer of the present invention is a laser desorption ionization mass spectrometer for measuring molecular weight of the sample by ionizing the sample on the basis of laser irradiation to the sample.

In the laser desorption ionization mass spectrometer, the sample to be measured is placed on the sample target, so that it is possible to favorably ionize the sample in case where laser is irradiated to the sample.

As described above, the sample target according to the present embodiment includes, as a sample support surface, a surface having a finely bumpy structure of order ranging from nanometer to several dozen micrometer, wherein the bumpy structure is arranged so that a plurality of concave portions are regularly formed.

Therefore, the sample target of the present embodiment has less unevenness in the shapes of the convex and concave than the sample target having an irregularly bumpy structure used in the conventional DIOS, so that it is possible to stabilize the ionization performance. That is, according to the sample target of the present embodiment, it is possible to accurately and stably perform the laser desorption/ionization mass spectrometry (DIOS) using no matrix. Thus, it is possible to enhance practicability of the sample target in the laser desorption/ionization mass spectrometry.

The sample target of the present embodiment can be effectively used as a sample table on which the sample is placed in case of performing the laser desorption ionization mass spectrometry and sample mass spectrometry using a mass spectrometer based on the laser desorption ionization mass spectrometry.

According to the method of the present embodiment for producing the sample target, it is possible to easily form the finely bumpy structure of order ranging from nanometer to several dozen micrometer on the sample support surface of the sample target by adopting the lithography. Therefore, it is possible to highly accurately and easily produce the sample target according to the present embodiment, that is, the sample target suitable for the laser desorption ionization mass spectrometry.

Further, the mass spectrometer of the present embodiment is used to perform mass spectrometry by using the sample target, so that it is possible to favorably ionize the sample in case where laser is irradiated to the sample to be measured. Thus, according to the foregoing mass spectrometer, it is possible to enhance the stability of analysis results.

As described above, in order to solve the foregoing problems, the sample target according to the present invention includes, as a sample support surface, a surface which is used to support a sample in ionizing the sample on the basis of laser irradiation so as to perform mass spectrometry and which has a finely bumpy structure of an order ranging from nanometer to several dozen micrometer, wherein a face of the sample support surface is coated with metal.

According to the foregoing arrangement, in the laser desorption ionization mass spectrometry which allows ionization of the sample without using any matrix, it is possible to enhance the efficiency and stability in the ionization of the sample.

Further, it is preferable that the metal is at least either platinum (Pt) or gold (Au).

According to the foregoing arrangement, in the laser desorption ionization mass spectrometry which allows ionization of the sample without using any matrix, it is possible to further enhance the efficiency and stability in the ionization of the sample, and it is possible to suppress oxidization of the sample support surface having the bumpy structure.

Further, it is preferable that the bumpy structure of the sample support surface is arranged so that a plurality of concave portions are regularly formed.

Further, in order to solve the foregoing problems, the sample target according to the present invention may be a sample target which includes, as a sample support surface, a surface which is used to support a sample in ionizing the sample on the basis of laser irradiation so as to perform mass spectrometry and which has a finely bumpy structure of an order ranging from nanometer to several dozen micrometer, wherein the bumpy structure of the sample support surface is arranged so that a plurality of concave portions are regularly formed.

According to the foregoing arrangement, the sample target of the present invention has less unevenness in the bumpy shape than a sample target which is adopted in conventional DIOS and has an irregularly bumpy structure, so that it is possible to stabilize the ionization performance. That is, according to the sample target of the present invention, it is possible to accurately and stably carry out laser desorption/ionization mass spectrometry (DIOS) using no matrix.

In the sample target whose sample support surface has such a bumpy structure that a plurality of concave portions are regularly formed, an interval of the concave portions adjacent to each other is preferably not less than 1 nm and less than 30 μm. In case where the interval of the concave portions adjacent to each other is too small (that is, less than 1 nm), this raises a problem that the structure of the sample target is weak. Adversely, in case where the interval of the concave portions adjacent to each other is too large (that is, not less than 30 μm), this raises a problem that the ionization efficiency drops. Therefore, it is preferable that the interval of the concave portions adjacent to each other is within the foregoing range. Note that, in order to further improve the ionization efficiency, it is necessary to raise the efficiency per unit area at which light energy is obtained. Thus, it is preferable that the interval of the concave portions adjacent to each other is less than 200 nm.

In the sample target whose sample support surface has such a bumpy structure that a plurality of concave portions are regularly formed, it is preferable that the interval of the concave portions is not less than 1 nm and less than 30 μm. Further, in the sample target of the present invention, it is preferable that a depth of each concave portion is not less than 1 nm and less than 30 μm.

According to the foregoing arrangement, for example, it is easy to obtain energy of ultraviolet laser of several hundred nanometer order, e.g., nitrogen laser of 337 nm, so that it is possible to obtain favorable ionization efficiency.

In the sample target whose sample support surface has such a bumpy structure that a plurality of concave portions are regularly formed, it is preferable that each of the concave portions may be a trench or a hole. Further, in the sample target of the present invention, when each of the concave portions is a trench, the concave portions may be disposed so that trenches in different directions intersect with each other. Further, in the sample target of the present invention, when each of the concave portions is a hole, the hole may have a cylindrical shape or a prismatic shape.

It is preferable that a material of at least the sample support surface of the sample target of the present invention is a semiconductor. Further, the sample target of the present invention may be entirely made of a single material such as the semiconductor, but may have a multilayer structure in which a layer constituting the sample support surface and a substrate made of a material different from a material of the sample support surface and serving as a basis of the sample support surface are laminated. In this case, the multilayer structure can be arranged so that the sample support surface is made of a semiconductor and the substrate is made of a metal. Further, also a coated structure whose sample support surface is formed by coating a surface of the substrate made of semiconductor with metal is regarded as a kind of the multilayer structure. Further, it is preferable that the semiconductor constituting the sample support surface is silicon.

According to the foregoing arrangement, in the laser desorption ionization mass spectrometry which allows ionization of the sample without using any matrix, it is possible to further improve the efficiency at which the sample is ionized.

A method according to the present invention for producing a sample target is a method for producing a sample target including, as a sample support surface, a surface which is used to support a sample in ionizing the sample on the basis of laser irradiation so as to perform mass spectrometry and which has a finely bumpy structure of an order ranging from nanometer to several dozen micrometer, and the method includes the step of coating a face of the sample support surface with metal.

According to the foregoing arrangement, the sample support surface of the sample target is coated with metal, so that it is possible to easily produce the sample target which allows more efficient and more stable ionization of the sample in the laser desorption ionization mass spectrometry which allows ionization of the sample without using any matrix.

Further, it is preferable to arrange the method according to the present invention for producing a sample target so as to include the step of repeatedly disposing concave portions on a surface of a substrate in accordance with lithography so that an interval of the concave portions is not less than 1 nm and less than 30 μm and a width of each of the concave portions is less than 30 μm, before performing the step of coating the face of the sample support surface with the metal, so as to form the sample support surface on the surface of the substrate.

The method according to the present invention for producing a sample target may be a method for producing a sample target including, as a sample support surface, a surface which is used to support a sample in ionizing the sample on the basis of laser irradiation so as to perform mass spectrometry and which has a finely bumpy structure of an order ranging from nanometer to several dozen micrometer, and the method includes the step of repeatedly disposing concave portions on a surface of a substrate in accordance with lithography so that an interval of the concave portions is not less than 1 nm and less than 30 μm and a width of each of the concave portions is less than 30 μm, so as to form the sample support surface on the surface of the substrate.

Further, in the method for producing the sample target whose sample support surface has the bumpy structure arranged so that a plurality of concave portions are regularly formed, the concave portions may be formed by using an electron beam drawing apparatus as the lithography technique. A more specific example of the lithography technique is as follows: After applying a photosensitive agent into a predetermined shape by using the electron beam drawing apparatus, etching is performed so as to form the concave portions. Note that, types of the etching include dry etching, chemical etching, electrolytic etching, and the like. However, because of the easiness to control the depth of each concave portion, it is preferable to adopt dry etching and chemical etching.

A mass spectrometer according to the present invention uses any one of the aforementioned sample targets so as to perform mass spectrometry. Further, it is preferable that the mass spectrometer is a laser desorption ionization mass spectrometer which irradiates laser to a sample to be measured so as to ionize the sample so that a molecular weight of the ionized sample is measured.

According to the foregoing arrangement, the mass spectrometer of the present invention performs mass spectrometry by using the foregoing sample target, so that it is possible to enhance efficiency and stability of sample ionization. Therefore, according to the foregoing mass spectrometer, it is possible to enhance accuracy and stability of analysis results.

### EXAMPLES

The present invention is more specifically described as follows based on Examples, but the present invention is not limited to the Examples. One skilled in the art can vary, modify, and change the foregoing arrangement without departing from the spirit and scope of the invention.

### Example 1

In the present Example, Pt was deposited on a sample support surface of a DIOS sample target by adopting a sputtering technique so that Pt had the thickness of 20 nm, thereby producing a sample target. The sample target coated with Pt was used to perform mass spectrometry on the basis of laser desorption ionization. A procedure and results thereof are explained as follows.

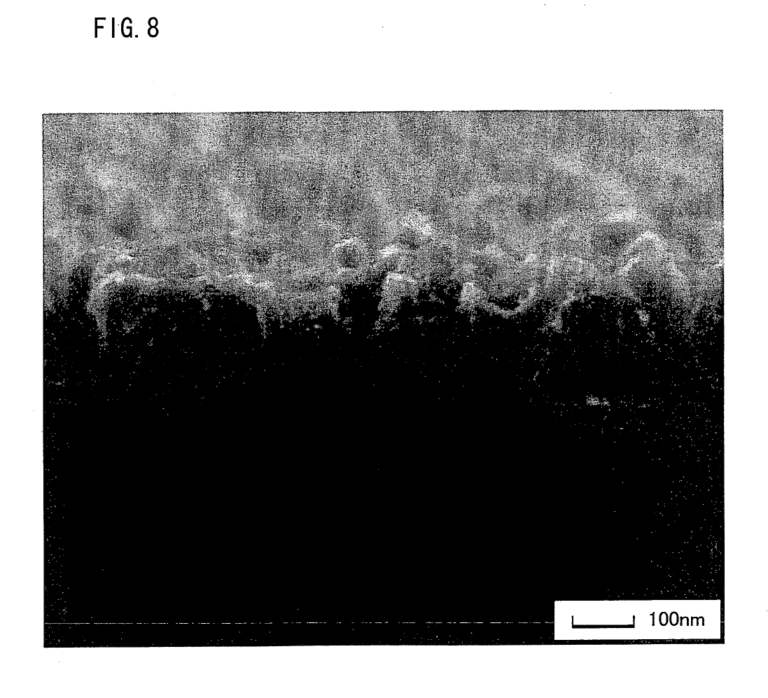

Pt was deposited on a DIOS sample target (product of Mass Consortium (U.S.)) by TFL-1000 ion sputtering device (product of JEOL) so as to have the thickness of 20 nanometer. FIG. 8 illustrates a cross sectional view obtained by observing a cross section of a treated sample support surface of the DIOS sample target with a scanning electron microscope. As illustrated in FIG. 8, in the bumpy structure of the sample support surface of the DIOS sample target, the shape of the concave portion is not constant, and an interval of convex portions or concave portions adjacent to each other in the bumpy structure was about 150 nm and a depth of each concave portion was 100 to 200 nm.

Next, mass spectrometry based on laser desorption ionization was performed by using the obtained sample target. As the sample to be measured, angiotensin I solution whose concentration was 1 mg/ml was used, and 0.2 μl of the solution was dropped onto the sample target and then was dried in air.

Subsequently, with the sample target, mass spectrometry based on laser desorption ionization in a reflectron mode was performed by using a time-of-flight mass spectrometer Voyager DE-Pro (product of Applied Biosystems). The following Table 1 shows a peak area of a protonated ion of angiotensin I molecule whose m/z value is 1297. Note that, “laser power” in the Table is a value indicative of laser intensity of Voyager DE-Pro.

TABLE

| | Laser Power | Peak Area | Laser Power | Peak Area |
|---|---|---|---|---|
| Example 1 | 2000 | 287005 | — | — |
| Comparative | 2000 | Not detected | 2700 | Not detected |
| Example 1 | | | | |
| Comparative | 2000 | Not detected | 2700 | Not detected |
| Example 2 | | | | |
| Comparative | 2000 | Not detected | 2500 | 9735 |
| Example 3 | | | | |
| Comparative | 2000 | 8352 | — | — |
| Example 4 | | | | |
| Comparative | 2000 | 10792 | — | — |
| Example 5 | | | | |

As shown in Table 1, in case where the sample target produced in the present Example was used, when the laser power was 2000, the peak area was 287005. This result shows that the DIOS sample target coated with Pt allows the angiotensin I molecule ion to be clearly detected. Accordingly, it was found that: use of the sample target produced in the present Examples allows the sample to be favorably ionized, so that it is possible to carry out accurate mass spectrometry.

### Comparative Example 1

With the foregoing sample, mass spectrometry based on laser desorption ionization was performed in the same manner as in Example 1 except that a stainless metal plate having no bumpy structure was used as the sample target and the sample support surface was not coated with metal. As shown in the Table 1, no ion was detected from the foregoing sample in the present Comparative Example. Further, even when the laser power was raised to 2700, no ion was detected from the foregoing sample.

### Comparative Example 2

With the foregoing sample, mass spectrometry based on laser desorption ionization was performed in the same manner as in Example 1 except that a silicon wafer having no bumpy structure was used as the sample target and the sample support surface was not coated with metal. As shown in the Table 1, no ion was detected from the foregoing sample in the present Comparative Example. Further, even when the laser power was raised to 2700, no ion was detected from the foregoing sample.

### Comparative Example 3

With the foregoing sample, mass spectrometry based on laser desorption ionization was performed in the same manner as in Example 1 except that the sample support surface of the sample target was not coated with metal. As shown in the Table 1, no ion was detected from the foregoing sample in the present Comparative Example. Further, when the laser power was raised to 2500, an ion was detected from the foregoing sample, but the peak area was only 9735. When the laser power exceeded 2500, the bumpy structure of the DIOS surface was broken, so that it was difficult to reuse the DIOS target.

### Comparative Example 4

With the foregoing sample, mass spectrometry based on laser desorption ionization was performed in the same manner as in Example 1 except that a stainless metal plate having no bumpy structure was used as the sample target. As shown in the Table 1, an ion was detected from the foregoing sample in the present Comparative Example, but the ion strength was so low that the peak area was 8352.

### Comparative Example 5

With the foregoing sample, mass spectrometry based on laser desorption ionization was performed in the same manner as in Example 1 except that a silicon wafer having no bumpy structure was used as the sample target. As shown in the Table 1, an ion was detected from the foregoing sample in the present Comparative Example, but the ion strength was so low that the peak area was 10792.

Accordingly, it was confirmed that the metal coating of the sample support surface having the finely bumpy structure plays an important role in the sample ionization performed with the sample target according to the present invention.

### Example 2

In the present Example, Pt was deposited on a porous plastic Portex by adopting a sputtering technique so as to have the thickness of 20 nm, thereby producing a sample target. The sample target coated with Pt was used to perform mass spectrometry on the basis of laser desorption ionization. A procedure and results thereof are explained as follows.

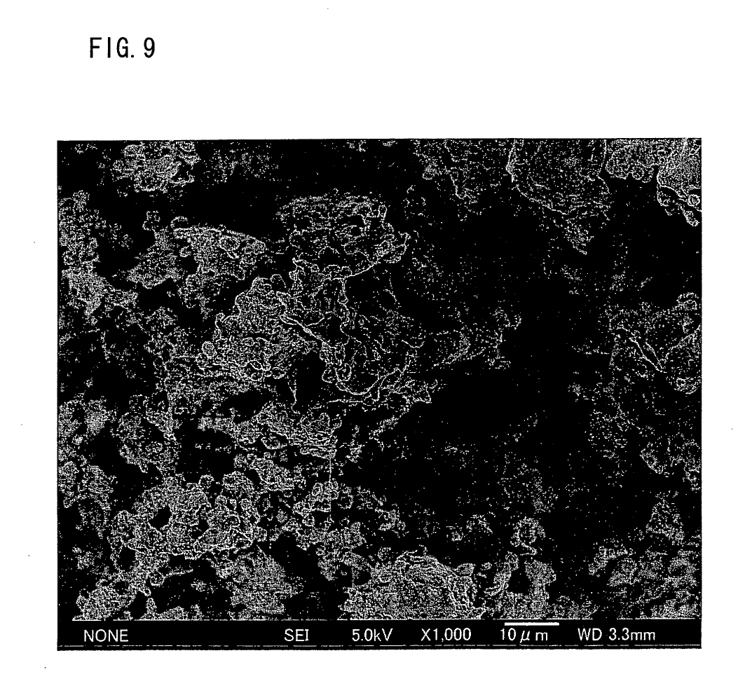

Pt was deposited on a porous plastic Porex (product of POREX TECHNOLOGIES (U.S.A.)) by TFL-1000 ion sputtering device (product of JEOL) so as to have the thickness of 20 nanometer. As illustrated in FIG. 9, the porous plastic has an irregular porous structure of about 800 nanometer to 5 micrometer.

Next, mass spectrometry based on laser desorption ionization was performed by using the obtained sample target. As the sample to be measured, angiotensin I solution whose concentration was 1 mg/ml was used, and 0.5 μl of the solution was dropped onto the sample target and then was dried in air.

Subsequently, with the sample target, mass spectrometry based on laser desorption ionization in a reflectron mode was performed by using a time-of-flight mass spectrometer Voyager DE-Pro (product of Applied Biosystem). With the laser power of 2150, a highly protonated ion of angiotensin I molecule whose m/z value was 1297 (peak area was 223000) was detected.

### Comparative Example 6

With the foregoing sample, mass spectrometry based on laser desorption ionization was performed in the same manner as in Example 2 except that the sample support surface of the sample target was not coated with metal. However, even though the laser power was raised, no ion was obtained.

### Example 3

In the present Example, Pt was deposited on an object glass, whose surface had been frictionally treated with a No. 400 sandpaper, by adopting a sputtering technique so as to have the thickness of 20 nm, thereby producing a sample target. The sample target coated with Pt was used to perform mass spectrometry on the basis of laser desorption ionization. A procedure and results thereof are explained as follows.

A surface of an object glass produced by MATSUNAMI GLASS IND., LTD. was frictionally treated with a No. 400 sandpaper. Then, Pt was deposited thereon by using a TEL-1000 ion sputtering device (product of JEOL) so as to have the thickness of 20 nanometer. The surface had a irregular porous structure of 10 nanometer to 2 micrometer.

Next, mass spectrometry based on laser desorption ionization was performed by using the obtained sample target. 0.5 μl of tetrahydrofuran solution of nonionic surfactant TRITON X-100 (product of ICN Biomedical) whose concentration was 1 mg/ml was dropped onto the sample target and then was dried in air.

Subsequently, with the sample target, mass spectrometry based on laser desorption ionization in a reflectron mode was performed by using a time-of-flight mass spectrometer Voyager DE-Pro (product of Applied Biosystem). With the laser power of 1600, Na-added ions of TRITON X-100 were detected with great intensity. A peak height of m/z 625 was 30000.

### Comparative Example 7

With the foregoing sample, mass spectrometry based on laser desorption ionization was performed in the same manner as in Example 3 except that a sample target whose sample support surface had not been coated with metal was used as the sample target. The sample was ionized, but the laser power was as high as 2400, and the ion strength was low. The peak height of m/z 625 was 2000.

### Comparative Example 8

With the foregoing sample, mass spectrometry based on laser desorption ionization was performed in the same manner as in Example 3 except that a sample target whose sample support surface had not been subjected to surface treatment with a sandpaper was used. However, no ion concerning the sample was obtained.

### Comparative Example 9

With the foregoing sample, mass spectrometry based on laser desorption ionization was performed in the same manner as in Example 3 except that a sample target whose sample support surface had been subjected to neither surface treatment nor metal deposition was used as the sample target. However, no ion concerning the sample was obtained.

### Example 4

In the present Example, Pt was deposited on a sample support surface of an SiO₂ substrate, having a plurality of concave portions regularly formed, by adopting a sputtering technique so as to have the thickness of 20 nm, thereby producing a sample target. The sample target coated with Pt was used to perform mass spectrometry on the basis of laser desorption ionization. A procedure and results thereof are explained as follows.

An SiO₂ substrate (product of Yamanaka Semiconductor) was treated with hexamethyldisilazane, and the treated SiO₂ substrate was spin-coated with an electron resist ZEP520 (ZEON CORPORATION), and the resultant was pre-baked at 180° C., and the pre-baked resultant was subjected to electron beam exposure by using an electron beam depiction device ELS-770 (product of ELIONIX). The exposed resultant was developed with ZED-N50 (product of ZEON CORPORATION), and the developed resultant was rinsed with ZMD-B (product of ZEON CORPORATION), thereby producing a resist pattern. Electron deposition was performed with respect to the resist pattern by using MB-02-5002 (product of ULVAC), and the resist was exfoliated with ZDMAC (product of ZEON CORPORATION), thereby producing an Ni mask. Thereafter, dry etching was performed with a reactive ion etching (RIE) device RIE-10NR (SAMCO) so as to form an SiO₂ pattern. Then, Pt was deposited thereon by using a TFL-1000 ion sputtering device (product of JEOL) so as to have the thickness of 20 nanometer.

There was obtained a sample target in which a square portion whose one side was 0.6 mm was processed into a trench structure whose convex portion was 150 nanometer and concave portion was 150 nanometer and depth was 200 nanometer. 12 sample targets of the same kind were produced.

0.5 μl of tetrahydrofuran solution of nonionic surfactant TRITON X-100 (product of ICN Biomedical) whose concentration was 1 mg/ml and polypropyleneglycol (product of Wako Pure Chemical Industries, Ltd.) whose average molecular weight was 700 was dropped onto the sample target and then was dried in air.

Subsequently, with the sample target, mass spectrometry based on laser desorption ionization in a reflectron mode was performed by using a time-of-flight mass spectrometer Voyager DE-Pro (product of Applied Biosystem).

With the sample target used in the present Example, sample ions of TRITON X-100 and polypropyleneglycol were intensely detected. Further, an average value of the peak height of m/z 625 of TRITON X-100 was 20000, and a standard deviation of the peak height of m/z 625 of TRITON X-100 was 2300. As such, it was confirmed that reproducibility of a spectrum is high.

### Example 5

In the present Example, a finely bumpy structure was formed on a silicon wafer by adopting electron beam lithography, thereby producing a sample target. Further, mass spectrometry based on laser desorption ionization was performed by using the sample target in the present Example. A procedure and results thereof are explained as follows.

A resist (NEB22 produced by Sumitomo Chemical Co., Ltd.) was applied to a silicon wafer (product of Sumitomo Mitsubishi Silicon Corp.) whose resistivity was 0.008 to 0.02 Ωcm, and an electron beam was irradiated from an electron beam drawing apparatus JBX-5000SI (product of JEOL), and then the resultant was treated with MFCD-26 (product of Shipley), thereby producing a fine structure of the resist. Subsequently, etching was carried out by using NLD etching device NLD-800 (product of ULVAC) on the basis of the dry etching method.

On the basis of the foregoing procedure, there was obtained a sample target in which a square portion whose one side was 0.6 mm was processed into a trench structure whose convex portion had a width (i.e., an interval of concave portions) of about 150 nm and concave portion had a width of about 170 nm and trench (concave portion) had a depth of about 150 nanometer. 12 sample targets of the same kind were produced. A surface structure of the obtained sample target was observed with a scanning electron microscope JSM-5310 (product of JEOL). As a result, a trench structure was confirmed as illustrated in FIG. 1.

Next, mass spectrometry based on laser desorption ionization was performed by using the obtained sample target. Tetrahydrofuran solution of nonionic surfactant TRITON X-100 (product of ICN Biomedical) whose concentration was 1 mg/ml and polypropyleneglycol (product of Wako Pure Chemical Industries, Ltd.) whose average molecular weight was 700 was used as the sample to be measured. 0.5 μl of each sample was dropped onto the sample target produced in the foregoing manner and then was dried in air.

Subsequently, with the sample target, mass spectrometry based on laser desorption ionization in a reflectron mode was performed by using a time-of-flight mass spectrometer Voyager DE-Pro (product of Applied Biosystem).

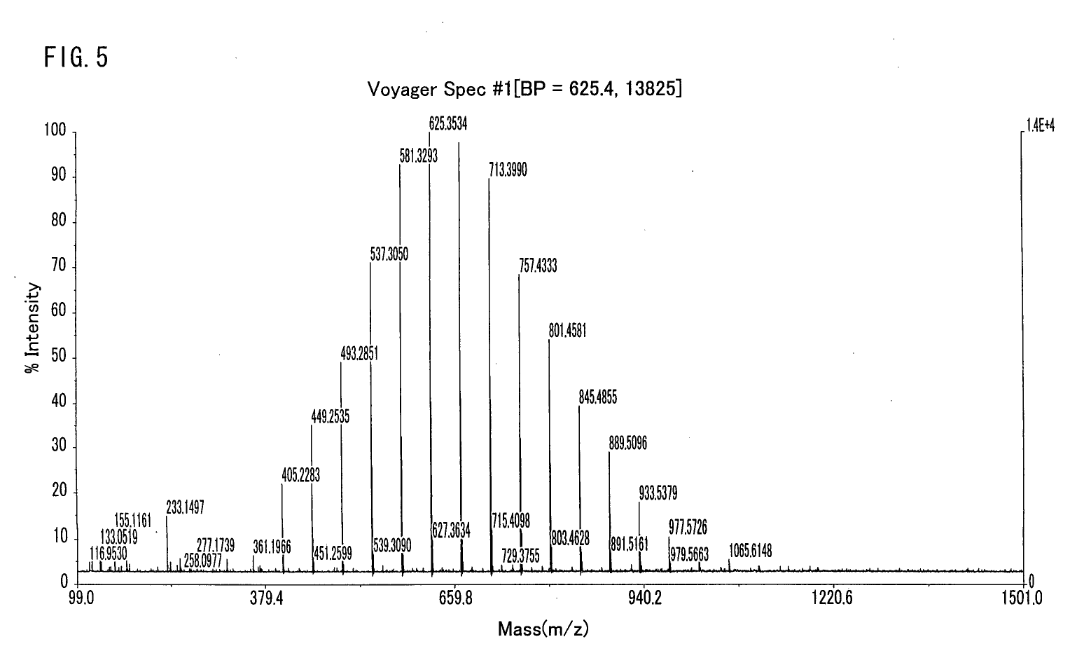

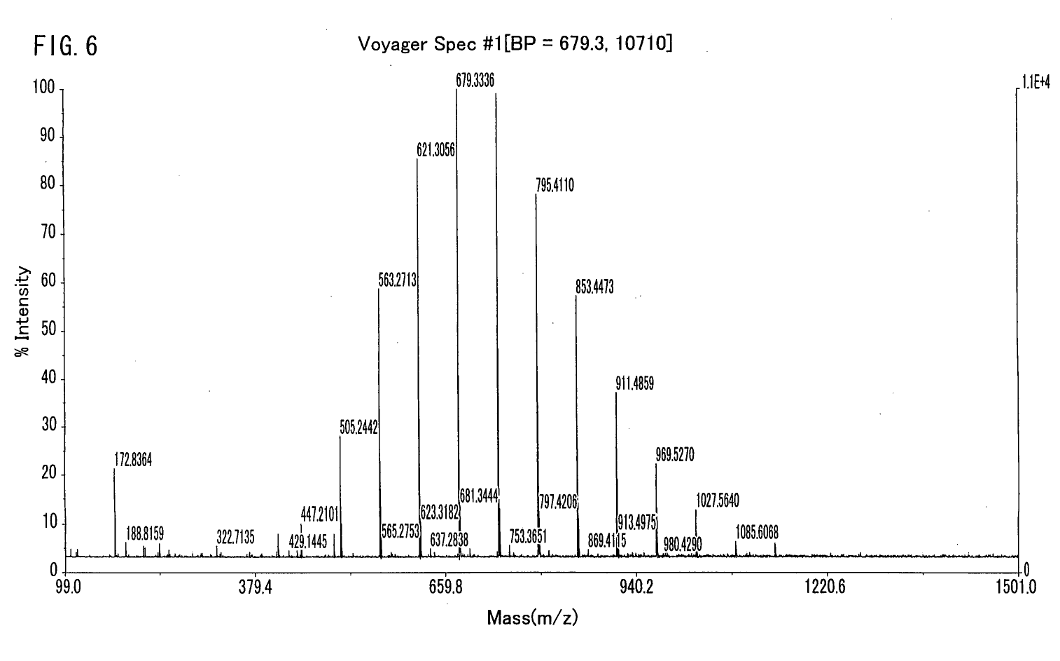

As a result, in all of the 12 sample targets produced in the present Example, it was confirmed that ions of both the TRITON X-100 sample and the polypropyleneglycol sample were intensely detected. Note that, FIG. 5 illustrates a mass spectrum of TRITON X-100 which was obtained by the mass spectrometry. FIG. 6 illustrates a mask spectrum of polypropyleneglycol. This result shows that use of the sample target produced in the present Example allows the sample to be favorably ionized and allows accurate mass spectrometry.

### Comparative Example 10

While, by using the conventional DIOS sample target illustrated in FIG. 7 as Comparative Example 10, mass spectrometry based on laser desorption ionization was performed in the same manner as in Example 5.

Note that, the DIOS sample target was produced with reference to Document 6. Specifically, a silicon wafer (product of Sumitomo Mitsubishi Silicon Corp.) whose resistivity was 0.008 to 0.02 Ωcm was used so as to produce the DIOS sample target on the basis of electrolytic etching. An equivalent mixture solution of 46% hydrogen fluoride (product of Wako Pure Chemical Industries, Ltd.) and ethanol (product of Wako Pure Chemical Industries, Ltd.) was used as electrolysis solution, and etching was performed with a current density of 8 mA/cm² for two fines while irradiating light from an incandescent lamp of 250 W at a distance of 15 cm. After performing the etching, the DIOS sample target was rinsed with ethanol. The produced sample target was reserved in ethanol. Under the same condition, 12 DIOS sample targets were produced. FIG. 7 illustrates a surface structure measured by a scanning electron microscope JSM-6700F (product of JEOL).

As a result, in all of the 12 sample targets produced in Comparative Example 10, it was confirmed that ions of both the TRITON X-100 sample and the polypropyleneglycol sample were intensely detected as in Example 5. However, when the sample target of Example 5 and the sample target of Comparative Example 10 were compared with each other in terms of an average value and a standard deviation of the peak height of m/z 625 of TRITON X-100. As a result of the comparison, the average value was 15000 and the standard deviation was 2000 in Example 5, and the average value was 15100 and the standard deviation was 6500 in Comparative Example 10. It was confirmed that there was little difference in the ion strength but the spectrum reproducibility in Example 5 was higher than Comparative Example 10. This result shows that the sample target of the present Example allows higher stability of analysis results than the sample target of Comparative Example 10.

### Comparative Example 11

With the foregoing sample, mass spectrometry based on laser desorption ionization was performed in the same manner as in Example 5 except that a sample target made of a metal plate having no finely bumpy structure was used as the sample target. However, no ion concerning the sample was obtained.

### Comparative Example 12

With the foregoing sample, mass spectrometry based on laser desorption ionization was performed in the same manner as in Example 5 except that a sample target made of a silicon wafer having no finely bumpy structure was used as the sample target. However, no ion concerning the sample was obtained.

This result shows that: in the sample target according to the present invention, the finely and regularly bumpy structure formed on its sample support surface plays an important role in ionizing the sample.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

According to the sample target of the present invention, in laser desorption ionization mass spectrometry, it is possible to perform ionization without using any matrix, and it is possible to realize more efficient and more stable sample ionization than the conventional sample target adopted in DIOS.

The laser desorption ionization mass spectrometry is widely adopted as mass spectrometry of various substances such as biopolymer, endocrine disrupter, synthetic polymer, metallic complex, and the like. The sample target of the present invention is a material effective in more accurately and more stably carrying out the laser desorption ionization mass spectrometry, so that the applicability of the present invention is high.

1. A sample target comprising, as a sample support surface, a surface which is used to support a sample in ionizing the sample on the basis of laser irradiation so as to perform mass spectrometry and which has a finely bumpy structure whose interval between concave portions or convex portions ranges from 1 nm to 10 μm, wherein
a face of the sample support surface is coated with metal.

2. The sample target as set forth in claim 1, wherein the metal is at least either platinum (Pt) or gold (Au).

3. The sample target as set forth in claim 1, wherein the bumpy structure of the sample support surface is arranged so that a plurality of concave portions are regularly formed.

4. A sample target comprising, as a sample support surface, a surface which is used to support a sample in ionizing the sample on the basis of laser irradiation so as to perform mass spectrometry and which has a finely bumpy structure of not less than 1 nm and less than 1 μm, wherein
the bumpy structure of the sample support surface is arranged so that a plurality of concave portions are regularly formed.

5. The sample target as set forth in claim 3, wherein an interval of the concave portions adjacent to each other is not less than 10 nm and less than 1 μm.

6. The sample target as set forth in claim 3, wherein a width of each of the concave portions is not less than 10 nm and less than 1 μm.

7. The sample target as set forth in claim 3, wherein a depth of each of the concave portions is not less than 10 nm and less than 1 μm.

8. The sample target as set forth in claim 3, wherein each of the concave portions is a trench or a hole.

9. The sample target as set forth in claim 8, wherein: when each of the concave portions is a trench, the concave portions are repeatedly disposed so that trenches in different directions intersect with each other.

10. The sample target as set forth in claim 8, wherein: when each of the concave portions is a hole, the hole has a cylindrical shape or a prismatic shape.

11. The sample target as set forth in claim 1, wherein a material of at least the sample support surface of the sample target is a semiconductor.

12. The sample target as set forth in claim 11, wherein the semiconductor is silicon.

13. A method for producing a sample target including, as a sample support surface, a surface which is used to support a sample in ionizing the sample on the basis of laser irradiation so as to perform mass spectrometry and which has a finely bumpy structure whose interval between concave portions or convex portions ranges from 1 nm to 10 μm,
said method comprising the step of coating a face of the sample support surface with metal.

14. The method as set forth in claim 13, comprising the step of repeatedly forming finely bumpy structures each of which has concave portions or convex portions on a surface of a substrate in accordance with lithography so that an interval of the concave portions or the convex portions ranges from 1 nm to 10 μm and a depth of each of the concave portions ranges from 10 nm to 1 μm, before performing the step of coating the face of the sample support surface with the metal, so as to form the sample support surface on the surface of the substrate.

15. A method for producing a sample target including, as a sample support surface, a surface which is used to support a sample in ionizing the sample on the basis of laser irradiation so as to perform mass spectrometry and which has a finely bumpy structure of not less than 1 nm and less than 1 μm,
said method comprising the step of repeatedly disposing concave portions on a surface of a substrate in accordance with lithography so that an interval of the concave portions is not less than 1 nm and less than 1 μm and a width of each of the concave portions is not less than 10 nm and less than 1 μm, so as to form the sample support surface on the surface of the substrate.

16. The method as set forth in claim 14, wherein the concave portions are formed by using an electron beam drawing apparatus as the lithography.

17. A mass spectrometer comprising the sample target as set forth in claim 1.

18. The mass spectrometer as set forth in claim 17, wherein the mass spectrometer is a laser desorption ionization mass spectrometer which ionizes the sample to be measured by irradiating laser to the sample so as to measure a molecular weight of the sample.

19. The sample target as set forth in claim 1, allowing ionization of the sample without using any matrix.
